(19) United States
(12) Patent Application Publication
(10) Pub. No.: US 2006/0130144 A1
(43) Pub. Date: Jun. 15, 2006

(54) Protecting computing systems from unauthorized programs

(75) Inventor: Charles R. Wernicke, Port Charlotte, FL (US)

Correspondence Address: SEED INTELLECTUAL PROPERTY LAW GROUP PLLC, 701 FIFTH AVE, SUITE 6300, SEATTLE, WA, 98104-7092, US

(73) Assignee: Delta Insights, LLC, Sarasota, FL (US)

(21) Appl. No.: 11/012,856

(22) Filed: Dec. 14, 2004

(51) Int. Cl. G06F 12/14

(52) U.S. Cl. 726/24

(57) ABSTRACT

A method, system, and computer-readable medium are described for assisting in protecting computing systems from unauthorized programs, such as by preventing computer viruses and other types of malware programs from executing during startup of a computing system and/or at other times. In some situations, computing system protection is provided by executing programs only if they have been confirmed as being authorized, which may be determined in various ways (e.g., if a program is automatically determined to be unchanged since a prior time when the program was authorized or to match a set of programs identified as being allowable, or if an appropriate user provides appropriate information). This abstract is provided to comply with rules requiring an abstract, and it is submitted with the intention that it will not be used to interpret or limit the scope or meaning of the claims.

### TECHNICAL FIELD

The following disclosure relates generally to techniques for protecting computing systems from unauthorized programs, such as to provide protection from computer viruses and other malware programs.

### BACKGROUND

As electronic interactions between computing systems have grown, computer viruses and other malicious software programs have become an increasing problem. In particular, malicious software programs (also referred to as “malware”) may spread in a variety of ways from computing systems that distribute the malware (e.g., computing systems infected with the malware) to other uninfected computing systems, including via email communications, exchange of documents, and interactions of programs (e.g., Web browsers and servers). Once malware is present on a computing system, it may cause a variety of problems, including intentional destruction or modification of stored information, theft of confidential information, and initiation of unwanted activities. While malware is currently typically found on computing systems such as personal computers and server systems, it may also infect a variety of other types of computing systems (e.g., cellphones, PDAs, television-based systems such as set-top boxes and/or personal/digital video recorders, etc.).

Malware programs may take a variety of forms, and may generally include any program or other group of executable instructions that performs undesirable or otherwise unwanted actions on a computing system, typically without awareness and/or consent of a user of the system. Some examples of malware programs include the following: various types of computer viruses and worms (which attempt to replicate and spread to other computing systems, and which may further perform various unwanted actions under specified conditions); spyware, adware, and other types of Trojans (which execute to perform various types of unwanted actions, generally without user awareness or consent, such as to gather confidential information about computing systems and/or their users, or to present unrequested advertising to users); hijackers (which modify settings of Web browsers or other software, such as to redirect communications through a server that gathers confidential information); dialers (which initiate outgoing communications, such as by dialing a toll number via a modem without user awareness or consent); rootkits (which may modify a computing system and/or gather confidential information to provide access to a hacker); mailbombers and denial-of-service initiators (which attempt to overwhelm a recipient by sending a large number of emails or other communications); and droppers (which act to install other malware on computing systems).

Once malware is installed on a computing system, it may execute in a variety of ways. Viruses, for example, typically attach themselves in some way to other executable programs such that a virus will be executed when the other program to which it is attached is executed (whether instead of or in addition to the other program). In addition, many types of malware attempt to install themselves on a computing system in such a manner as to execute automatically at startup of the computing system, typically just after the boot process of the computing system loads and initiates execution of the operating system. In particular, many types of computing systems and operating systems allow programs to be configured to automatically execute during the next or all startups of the computing system—for example, for computing systems executing some versions of Microsoft's Windows operating system, programs listed in a “Startup” folder will be automatically executed at startup, as will programs specified in other manners to be executed at startup (e.g., in appropriate entries of a “registry” that holds various configuration and other information for the operating system, as well as in other configuration files such as a “Win.ini” file or a “system.ini” file). Some computing systems and operating systems may further allow multiple users to each have separate computing environments, and if so additional startup activities may be taken when a user logs in or otherwise initiates their computing environment.

In addition to malware programs that are installed and executed without awareness of a user, other types of unauthorized or otherwise undesirable programs may also be executed on computing systems (e.g., at startup) in some situations, including programs that are inappropriate for a computing system that is controlled by or shared with another entity (e.g., a program installed by a user on a corporate computing system at work that is not appropriate for that corporate environment). Even when such programs do not take malicious actions, they may create various other problems, including hindering computing system performance by using valuable computing resources, causing conflicts with other programs, and providing functionality that is not authorized.

Accordingly, given the existing problems regarding malware and other undesirable programs, it would be beneficial to provide techniques that address at least some of these problems, as well as to provide additional benefits.

### BRIEF DESCRIPTION OF THE DRAWINGS

FIG. 1 is a network diagram illustrating an example embodiment in which the described techniques may be used.

FIG. 2 is a block diagram illustrating an example embodiment of a system for protecting a computing system using the described techniques.

FIG. 3 is a flow diagram of an embodiment of the Target Identifier routine.

FIG. 4 is a flow diagram of an embodiment of the Target Use Authorizer routine.

FIG. 5 is a flow diagram of an embodiment of the Target Use Preventer routine.

FIG. 6 is a flow diagram of an embodiment of the Protection Facilitator routine.

### DETAILED DESCRIPTION

A software facility is described that assists in protecting computing systems from unauthorized programs. In some embodiments, the software facility protects a computing system by preventing computer viruses and other types of malware programs from executing on the computing system, such as by preventing any program from executing if the program has not been confirmed as being authorized. In addition, the protective activities may be performed at various times in various embodiments, including at startup of the computing system and/or during regular operation of the computing system after the startup.

The software facility may automatically confirm that a program is authorized to be executed in various ways in various embodiments. For example, in some embodiments a determination is made as to whether a program has changed since a prior time at which the program was authorized (e.g., since a last successful execution of the program), and the program is automatically confirmed as being authorized if it is unchanged—in such embodiments, a program may be determined to be unchanged in various ways, as discussed in greater detail below. In addition, in some embodiments information about programs that have been identified as being authorized or otherwise allowable (e.g., based on not being or including any malware) is used, such as to automatically confirm a program as being authorized if it qualifies as an identified allowable program—such information about identified allowable programs may be gathered and used in various ways, as discussed in greater detail below. Moreover, in some embodiments a program may be automatically confirmed as being authorized for a computing system based on an indication from a user associated with the computing system, such as by querying the user for an authorization indication at the time of program installation and/or attempted execution. Programs may further be automatically confirmed as being authorized in other manners in at least some embodiments, as discussed in greater detail below.

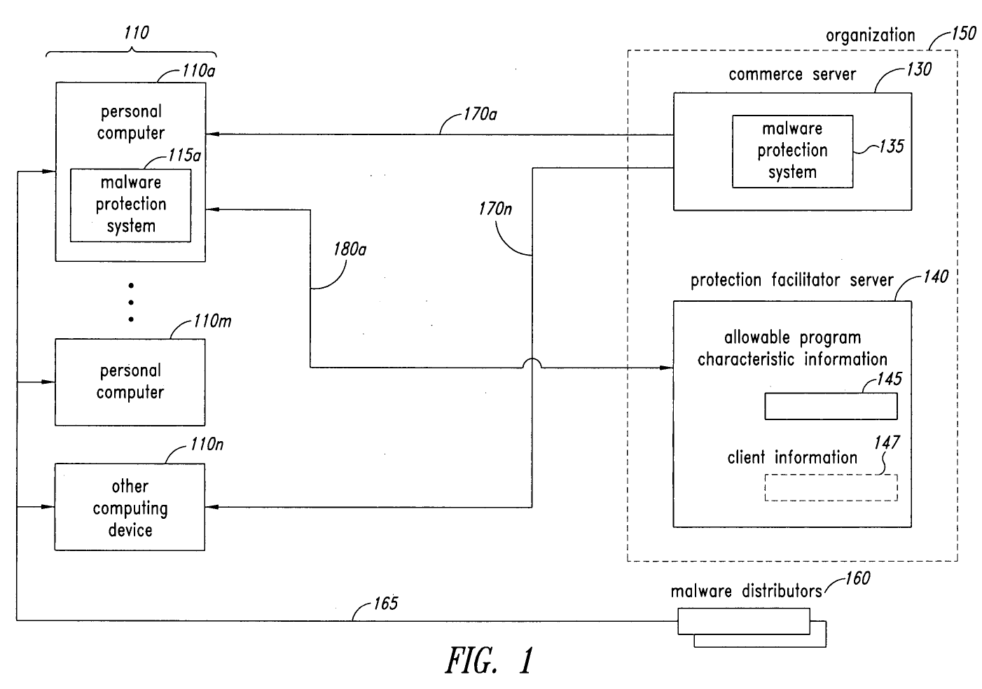

As an illustrative example, FIG. 1 illustrates various computing systems using some of the described techniques. In particular, FIG. 1 illustrates various client computing systems 110 that include personal computers 110a-110m and one or more other computing devices 110n, as well as one or more malware distributor systems 160 that attempt to install malware on the client computing systems via various communications 165. The other computing devices 110n may be of a variety of types, including cellphones, PDAs, electronic organizers, television-based systems (e.g., set-top boxes and/or personal/digital video recorders), network devices (e.g., firewalls, printers, copiers, scanners, fax machines, etc.), cordless phones, devices with walkie-talkie and other push-to-talk capabilities, pagers, Internet appliances, workstations, servers, laptops, etc.

FIG. 1 also illustrates a commerce server 130 that stores one or more copies of a malware protection system software facility 135, such as to make the malware protection system available to the client computing systems (e.g., for a fee). In this example, the commerce server distributes 170a and 170n copies of the malware protection system to personal computer 110a and other computing device 110n, respectively, such as by electronically downloading the copies to those client computing systems after users (not shown) of the client computing systems purchase the copies. In other embodiments, malware protection systems may instead be installed on client computing systems in other ways, such as from a transportable computer-readable medium (e.g., a CD or DVD) that contains the malware protection system, or instead by distributing the client computing systems with the malware protection systems pre-installed. As is shown in detail for personal computer 110a, a copy 115a of the malware protection system is then stored on the personal computer (e.g., in memory and/or on a hard disk) for use in providing malware protection capabilities for the personal computer, such as by installing a software protection program portion of the malware protection system in such a manner as to execute automatically at startup of the personal computer—the other computing device 110n and optionally one or more of the other personal computers may similarly have local copies of the malware protection system, but such copies are not illustrated here for the sake of simplicity. While also not illustrated here, in other embodiments some or all of the malware protection system may instead provide protection for a computing system from a remote location, such as by executing on the commerce server or another computing system and interacting with the computing system being protected.

FIG. 1 also illustrates a protection facilitator server 140 that assists the executing malware protection systems on the client computing systems in providing protection in this illustrated embodiment. In particular, in this illustrated embodiment, the protection facilitator server stores information 145 about programs that have been identified as being allowable, such as a copy of each of the programs and/or one or more other distinctive characteristics of each of the programs. As a copy of the malware protection system executes on a client computing system, it may then communicate with the protection facilitator server to use the information about the allowable programs to determine whether to authorize a program on the client computing system, such as is illustrated by communications 180a between the malware protection system 115a and the protection facilitator server. The communications may exchange and use information in various ways, such as by a malware protection system on a client computing system sending information to the protection facilitator server about a program on the client computing system (e.g., to send information about a program as part of determining whether to authorize the program to execute on the client computing system, or to send information about a program so that information about the program may be added to the allowable program information as appropriate) and/or by receiving information from the protection facilitator server about one or more of the allowable programs (e.g., to download and store the information locally, not shown, for later use).

The protection facilitator server in the illustrated embodiment also optionally stores various client information 147 about some or all of the client computing systems and/or users of those systems. Such information may be of a variety of types and be used for a variety of reasons, such as to determine whether a client computing system is authorized to provide and/or obtain information about allowable programs (e.g., based on information received from the commerce server related to acquisition of the malware protection system, such as whether the client computing system and/or its user has a current subscription), to store preference information for the client computing system, to store history information about prior interactions with the client computing system, to store backup copies of some or all programs on the client computing system (e.g., for use in restoring programs that have become infected with malware or otherwise changed), to store information about characteristics of programs on the client computing system (e.g., for later use in determining whether the programs have been changed), etc. In other embodiments, the client computing systems may instead store some or all such information locally, or such information may instead not be used.

In the illustrated embodiment, the commerce server and protection facilitator server are illustrated as optionally being under control of a single organization 150 (e.g., a merchant, such as a manufacturer, distributor or seller of the malware protection system), although in other embodiments the types of functionality may be provided by distinct organizations or in other manners (e.g., by a single computing system acting both as a commerce server and a protection facilitator server, by having multiple copies of one or both of the commerce server and protection facilitator server, or by not having the functionality of one or both of the commerce server and protection facilitator server).

In addition, while the actions of only the copy 115a of the malware protection system are illustrated in this example, malware protection systems on other client computing systems may also interact with the protection facilitator server in a manner similar to that discussed for copy 115a. Moreover, in embodiments in which the malware protection systems do interact with a remote protection facilitator server in the illustrated manner, the interactions may provide a variety of benefits. For example, by interacting with the remote protection facilitator server, a malware protection system may obtain or use the most recent information about programs identified as being allowable. In addition, in at least some embodiments in which the malware protection systems provide information to the protection facilitator server about programs on their client computing systems, the protection facilitator server may use that information to identify new allowable programs rapidly in a distributed manner, which may then benefit other malware protection systems.

Thus, the malware protection system is able to protect one or more client computing systems from malware, such as when executed on those client computing systems. As noted, malware programs may take a variety of forms, and may attempt to execute in various ways. Thus, in some embodiments, the malware protection system protects against malware and other unauthorized programs by preventing the programs from executing, although in other embodiments other techniques may be used (e.g., preventing the programs from being installed and/or preventing existing programs from being modified), whether instead of or in addition to preventing the programs from executing. In particular, in some embodiments the malware protection system is installed in such a manner as to execute first during the computing system startup (e.g., in a manner supported by an operating system of the computing system, such as to install at least a portion of the malware protection system as a service for the Microsoft Windows operating system), enabling it to intervene and prevent any other subsequent startup programs from executing as appropriate. Moreover, in at least some such embodiments the malware protection system may continue to execute after startup, thus enabling it to similarly prevent programs from executing after startup as appropriate

In order to prevent programs from executing as appropriate, the malware protection system first automatically identifies potential malware targets to evaluate, which may be performed in various ways in various embodiments. For example, in embodiments in which the malware protection system executes during startup of a computing system, the malware protection system may analyze the computing system configuration to identify other programs that are configured to execute during startup (e.g., in a manner specific to a type of the computing system and/or operating system) and/or may dynamically monitor attempted execution of programs in various ways (e.g., by using corresponding functionality provided by the operating system, or instead by intercepting appropriate calls to the operating system). Similarly, in embodiments in which the malware protection system executes after startup of a computing system, the malware protection system may analyze the computing system configuration to identify all executable programs and/or may dynamically monitor attempted execution of programs.

After one or more potential malware targets have been identified for a computing system, the malware protection system automatically determines whether the potential targets are verified or otherwise confirmed as being authorized for the computing system, which may be performed in various ways in various embodiments. For example, as previously noted, in some embodiments a determination is made as to whether a program has changed since a prior time, and the program is automatically confirmed as being authorized if it is unchanged. In particular, in some embodiments the malware protection system causes various information to be stored for programs, such as for programs that execute and/or for programs that are identified as being authorized. The stored information for a program may include a copy of the program (e.g., for later use in restoring a copy of a program that has been changed due to a malware infection or other reason) and/or other characteristics of the program that can later be used to determine whether the program has changed. Such characteristics for a program may include, for example, one or more of the following: various metadata associated with the program, such as a size of the file or other data record (e.g., a database record) with or in which the program is stored, or a creation and/or modification date associated with the file or data record; one or more values generated based on the contents of the program (e.g., a checksum value, CRC (“cyclic redundancy check”) value, or hash-based value); subset of the program contents (e.g., a signature having a distinctive pattern of one or more bytes of the program); the full program contents; etc. Once program characteristics are available for a program, values for those program characteristics may later be generated for a then-current copy or version of the program and compared to the values for the prior program characteristics in order to determine whether they match. In some embodiments, any change in one or more of the specified characteristics of a program will result in a determination that the program has been changed, while in other embodiments values for at least some program characteristics may be considered to match prior values for those program characteristics if the differences are sufficiently small. In other embodiments, various other techniques may be used to determine whether a program has changed, such as encryption-based digital signatures.

In addition to using change detection techniques to automatically determine whether a potential target is verified or otherwise confirmed as being authorized for a computing system, the malware protection system may also use information about programs that have been previously identified as being authorized or otherwise allowable for that computing system or more generally for any computing system. For example, as previously noted with respect to FIG. 1, information about identified allowable programs may in some embodiments be aggregated in a distributed manner at one or more centralized servers from multiple remote malware protection systems and/or may be distributed or otherwise made available to such malware protection systems from such centralized servers. Information about a potential malware target may be compared to information about identified allowable programs in various ways, including in a manner similar to that discussed with respect to identifying program changes. In particular, the information stored for each of some or all of the identified allowable programs may include a program characterization, such as to include identifying information for the program (e.g., a name and/or type of the program) and/or information about one or more characteristics of the allowable program (e.g., values for each of one or more of the characteristics). Corresponding information for a potential malware target may then be compared to the stored information for the identified allowable programs in order to determine whether a match exists. In this manner, once common executable programs (e.g., word processing programs, utility programs, etc.) are identified as allowable, the information about those programs may be used to automatically authorize the typical programs used by many or most computing systems to be protected. In addition, programs may be identified as being allowable in various ways, such as by gathering information about programs from trusted sources (e.g., program manufacturers or distributors), by automatically analyzing information about target programs on client computing systems that have not yet been identified as being allowable (e.g., by using various automated techniques to scan for viruses and other malware, such as to automatically identify a program as being allowable if no malware is identified), by human-supplied information or analysis (e.g., from users of the client computing systems and/or users affiliated with the organization providing the malware protection system and/or the protection facilitator server, etc.).

Furthermore, a potential target may be verified or otherwise confirmed as being authorized for a computing system based on authorization information received from an authorized or otherwise qualified user, such as a user of the computing system. For example, when installing and/or initiating execution of a program on the computing system, a user may provide an indication that a program is to be treated as being authorized (e.g., for a single time or as a default unless otherwise overridden), even if the program is not among the identified allowable programs and/or has been changed. In some embodiments, a user of the computing system may override any other determination that a program is not authorized by providing such an authorization indication, while in other embodiments restrictions may be placed on the use of such authorization indications (e.g., on which users are allowed to provide such authorization indications and/or in which situations such authorization indications can be used, such as to override another determination that a program is not authorized). Moreover, in some embodiments the malware protection system may solicit such authorization indications from users in at least some situations (e.g., for programs that cannot be automatically determined to be authorized in other manners), such as by interactively querying a user as to whether a specified program is authorized and/or by storing information about unauthorized programs in a manner available to users (e.g., in logs or reports).

In some embodiments, the malware protection system may also employ various other techniques to automatically determine that programs are confirmed as being authorized, such as in conjunction with one or more other previously discussed techniques. For example, programs may be automatically scanned or otherwise analyzed to verify that the programs do not contain programs that have been identified as being disallowable (e.g., identified malware programs). In addition, in at least some embodiments the malware protection system may operate in conjunction with one or more other types of protective systems, such as systems designed to search for and remove known malware programs, or systems that automatically update programs and/or data on a client computing system (e.g., to update antivirus or other malware software and configuration data).

If a target malware program is not determined to be authorized, the malware protection system may prevent the target from executing in a variety of ways. For example, if the target is identified during an attempt to initiate execution of the target, that attempt may be blocked (e.g., by notifying the operating system not to execute the target program). Moreover, additional actions may be taken in some embodiments to prevent execution of a target known to be disallowable on a computing system, such as by removing the target from the computing system and/or restoring a prior clean copy of a changed target. If it is unknown whether a target on a computing system is malware but it is not otherwise authorized, the target may instead be quarantined in such a manner that it is stored on the computing system but not allowed to execute (e.g., so as to enable a user to manually authorize the quarantined target, to allow further analysis of the target to be performed, and/or to later allow the target to be executed if it is added to the group of identified allowable programs).

Thus, a variety of actions may be taken by the malware protection system in various embodiments to prevent target programs from executing. In addition, in some embodiments the malware protection system employs multiple levels of protection. For example, if a malware program still manages to execute on a computing system when at least some of the previously described techniques are used, the malware protection system may employ additional safeguards to disable that malware (e.g., by disallowing manual user overrides for some or all types of programs, by adding additional restrictions regarding whether a program is determined to be unchanged from a prior copy of the program and/or whether the prior copy of the program is treated as having been authorized, by adding additional restrictions regarding whether a program is determined to match an identified allowable program, by adding additional restrictions regarding which programs are treated as identified allowable programs, etc.). In addition, the malware protection system may interact with one or more other systems to facilitate protection of a computing system (e.g., another type of malware system and/or a utility program to correct various types of problems), and may use functionality provided by the computing system and/or its operating system to enhance protection (e.g., executing a computing system in a “safe mode” of the operating system that disables many types of programs).

As discussed above, in at least some embodiments the malware protection system prevents unauthorized programs from executing on a computing system. In addition, in some embodiments the malware protection system provides further protection by extending similar functionality with respect to other types of stored data, such as documents and other files created by programs, configuration information for application programs and/or the operating system, etc. In particular, in such embodiments the malware protection system prevents inappropriate data from being used on a computing system, such as by automatically disallowing use of data unless the data is confirmed to be authorized for use. As with programs, data may be determined to be authorized for use in a variety of ways, including by the data being unchanged since a prior time at which the data was authorized, by the data matching information about data that has been identified as being allowable, by the data being used by a program that has been determined to be authorized, based on an indication from a user associated with the computing system, etc.

In addition, while some illustrated examples discuss the use of the malware protection system to protect against malware programs that are intentionally malicious, at least some embodiments of the malware protection system may further protect client computing systems from other changes to programs and/or data that are not malicious (e.g., that are inadvertent or that have unintentional effects). For example, a user of a computing system may make changes to configuration of a program that inadvertently cause the changed program to be defective or even destructive. If so, the malware protection system may prevent the changed program from executing, thus mitigating any destructive effects, and may further facilitate restoration of a prior copy of the program without the undesirable changes. In addition, undesirable changes to programs may occur in other ways that are not initiated by a user (e.g., due to hardware problems on the computing system), and if so the malware protection system may similarly prevent any changed programs from executing and facilitate restoration of prior copies of such programs without the undesirable changes.

For illustrative purposes, some embodiments are described below in which specific examples of a malware protection system protect specific types of computing systems in specific ways from specific types of problems. However, those skilled in the art will appreciate that the techniques of the invention can be used in a wide variety of other situations, including to protect from changes that occur in manners other than based on malware, and that the invention is not limited to the exemplary details discussed.

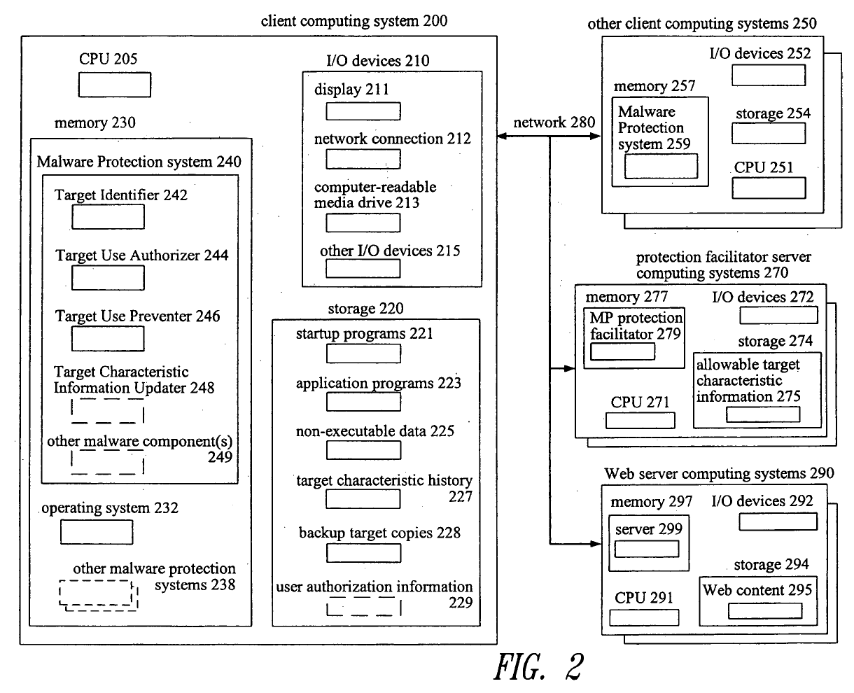

FIG. 2 illustrates a client computing system 200 on which an embodiment of a Malware Protection (“MP”) system facility is executing, as well as one or more other client computing systems 250 that each similarly have a copy of the MP system 259 executing in memory 257 but that are not illustrated in detail for the sake of brevity. One or more Web server computing systems 290 are also illustrated, such as to provide content to users (not shown) of the client computing systems, as well as to in some cases spread malware programs to the client computing systems. One or more protection facilitator server computing systems 270 are also illustrated, such as to assist the MP systems on the client computing systems in automatically determining that targets are authorized based on matching identified allowable targets.

The computing system 200 includes a CPU 205, various input/output (“I/O”) devices 210, storage 220, and memory 230. The I/O devices include a display 211, a network connection 212, a computer-readable media drive 213, and other I/O devices 215. An operating system 232 is executing in memory, as is an embodiment of the MP system 240, which includes a Target Identifier component 242, a Target Use Authorizer component 244, and a Target Use Preventer component 248. In the illustrated embodiment, the MP system 240 is executed at the beginning of the startup of the client computing system 20 in order to protect the computing system from malware.

In particular, the Target Identifier component automatically identifies potential malware and other targets, such as by identifying appropriate information on storage 220 (e.g., startup programs 221, application programs 223 and/or non-executable data 225).

The Target Use Identifier component automatically determines whether to allow use of one or more identified potential malware or other targets for a computing system based on whether those targets are confirmed to be authorized, such as by identifying characteristic information for the target and comparing the identified characteristic information to prior characteristic information for the target from a target characteristic history database 227 (e.g., to determine whether the target has been changed) and/or by interacting with the MP protection facilitator system 279 on the protection facilitator server to compare the identified characteristic information to characteristic information 275 for targets identified as being allowable. The Target Use Identifier component may also optionally obtain information from one or more users of the client computing system 200 regarding whether targets are authorized and use such optional stored information 229 to determine whether a target is authorized.

The Target Use Preventer component then prevents targets that are not determined to be authorized from being used, such as by blocking target programs from executing. In addition, in some embodiments, the Target Use Preventer may restore changed targets by replacing the changed target with a backup copy 228 of the target.

The illustrated embodiment of the MP system 240 also includes an optional Target Characteristic Information Updater component 248, which operates to provide information to the MP protection facilitator system 279 about targets identified as being allowable, although in other embodiments the MP protection facilitator system may not gather such information from MP systems or instead may gather such information in other manners. For example, when a Target User Authorizer component sends target information to the MP protection facilitator system to determine whether the target matches any identified allowable targets, the MP protection facilitator system may analyze received information about targets that are not yet identified as being allowable in an attempt to expand the group of identified allowable targets.

As is illustrated, the MP system 240 may also in at least some embodiments include one or more other malware components 249 and/or may interact with one or more other systems 238 that provide malware-protection-related functionality.

Those skilled in the art will appreciate that computing systems 200, 250, 270 and 290 are merely illustrative and are not intended to limit the scope of the present invention. Computing system 200 may instead be comprised of multiple interacting computing systems or devices, and may be connected to other devices that are not illustrated, including through one or more networks such as the Internet or via the World Wide Web (“Web”). More generally, a “client” or “server” computing system or device may comprise any combination of hardware or software that can interact, including (without limitation) desktop or other computers, network devices, PDAs, cellphones, cordless phones, devices with walkie-talkie and other push-to-talk capabilities, pagers, electronic organizers, Internet appliances, television-based systems (e.g., using set-top boxes and/or personal/digital video recorders), and various other consumer products that include appropriate inter-communication capabilities. In addition, the functionality provided by the illustrated MP system components may in some embodiments be combined in fewer components or distributed in additional components. Similarly, in some embodiments the functionality of some of the illustrated components may not be provided and/or other additional functionality may be available.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software components and/or modules may execute in memory on another device and communicate with the illustrated computing system/device via inter-computer communication. Some or all of the system components or data structures may also be stored (e.g., as software instructions or structured data) on a computer-readable medium, such as a hard disk, a memory, a network, or a portable media article to be read by an appropriate drive or via an appropriate connection. The system components and data structures can also be transmitted via generated data signals (e.g., by being encoded in a carrier wave or otherwise included as part of an analog or digital propagated signal) on a variety of computer-readable transmission mediums, including wireless-based and wired/cable-based mediums, and can take a variety of forms (e.g., as part of a single or multiplexed analog signal, or as multiple discrete digital packets or frames). Such computer program products may also take other forms in other embodiments. Accordingly, the present invention may be practiced with other computer system configurations.

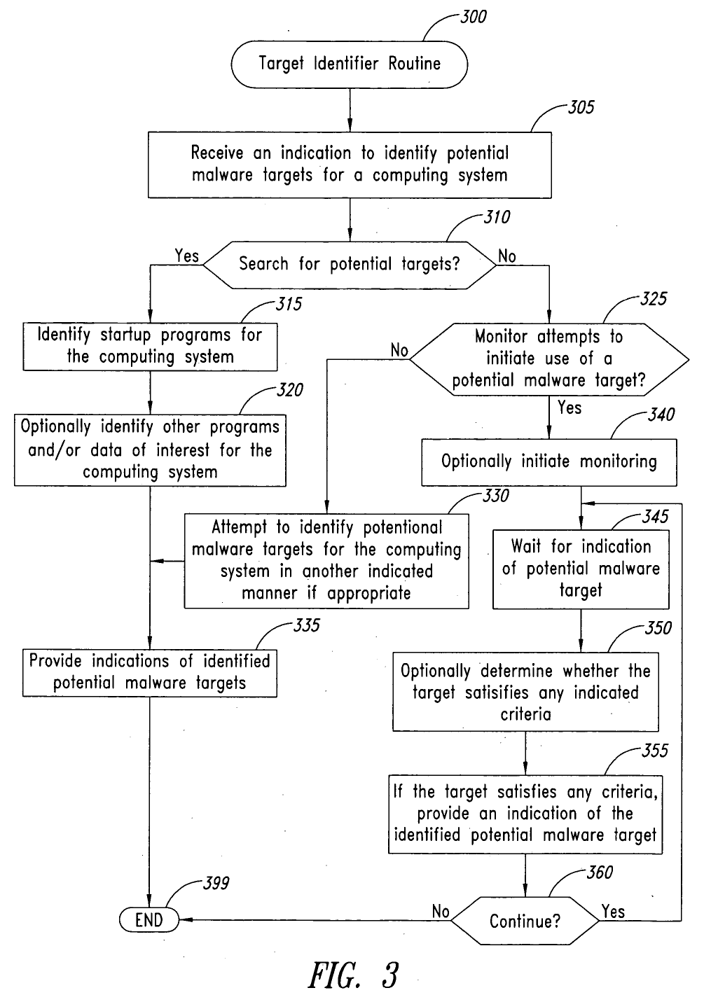

FIG. 3 is a flow diagram of an embodiment of the Target Identifier routine 300. The routine may, for example, be provided by execution of an embodiment of the Target Identifier component 242 of FIG. 2, such as to in this illustrated embodiment automatically identify potential malware and other targets for a computing system in order to enable a determination of whether to allow use of those targets. The routine may, for example, execute at startup of the computing system along with other components of an embodiment of a malware protection system, or alternatively may in some embodiments execute remotely from the computing system. In addition, while in the illustrated embodiments the targets may include data as well as programs, in other embodiments the targets may merely be programs.

The routine begins at step 305, where an indication is received to identify potential malware targets for a computing system, such as based on initiation of the routine as part of execution of the malware protection system. Alternatively, if the indication in step 305 is a request received from another system or user, the routine may in other embodiments verify that the requester is authorized to make the request before performing additional steps. In the illustrated embodiment, the routine continues to step 310 to determine whether a search for potential targets is to be performed (e.g., based on an indication received in step 305 or by other conditions, such as to perform the search on only the first execution of the routine on a computing system), such as by searching some or all of one or more hard disks of the computing system, although in some embodiments the routine may not perform such searching (e.g., if the routine merely monitors for attempted execution of programs). If a search for potential targets is to be performed, the routine continues to step 315 to identify startup programs for the computing system (e.g., by searching appropriate locations of the computing system that contain information about startup programs), and in step 320 optionally identifies other programs and/or data of interest that are potential targets (e.g., all programs and/or all files or other data records). In other embodiments, step 320 may not be performed if the malware protection system executes only at startup, or alternatively the startup programs may not be identified separately in step 315 if the routine searches for various types of programs in the same manner. After step 320, the routine continues to step 335 to provide indications of the identified potential malware targets, such as for use by the Target Use Authorizer routine or other requester.

If it was instead determined in step 310 that a search for potential targets is not to be performed, the routine continues to step 325 to determine whether to dynamically monitor attempts to initiate use of a program and/or data that is a potential malware target (e.g., based on an indication received in step 305 or by other conditions, such as to perform the monitoring during startup of the computing system), although in some embodiments the routine may not perform such monitoring (e.g., if the routine merely identifies in advance the potential targets of interest, such as by searching the computing system) or may monitor only for some or all programs. If it is determined that the routine is not to dynamically monitor use initiation attempts, the routine continues to step 330 to attempt to identify potential malware targets for the computing system in another indicated manner if appropriate, and then proceeds to step 335.

However, if it is instead determined that the routine is to dynamically monitor use initiation attempts, the routine continues to step 340 to optionally initiate the monitoring, such as by interacting with the operating system to receive requested types of notifications (e.g., for each attempt to initiate execution of a program and/or each read of data), although in other embodiments the routine may receive the desired information without explicitly initiating the monitoring or without performing the initiation at this time (e.g., if the monitoring initiating need be performed only once, which has already occurred). The routine then waits in step 345 for an indication of one or more potential malware targets, and in step 350 optionally determines whether the potential targets satisfy any indicated criteria (e.g., types of programs and/or data, or a time at which the monitoring is to occur, such as at startup). If a potential target does satisfy any criteria or if no such criteria are in use, the routine in step 355 provides an indication of the identified potential malware target, such as in a manner similar to step 335. If it is then determined in step 360 to continue the monitoring, the routine returns to step 345. Otherwise, or after step 335, the routine continues to step 399 and ends.

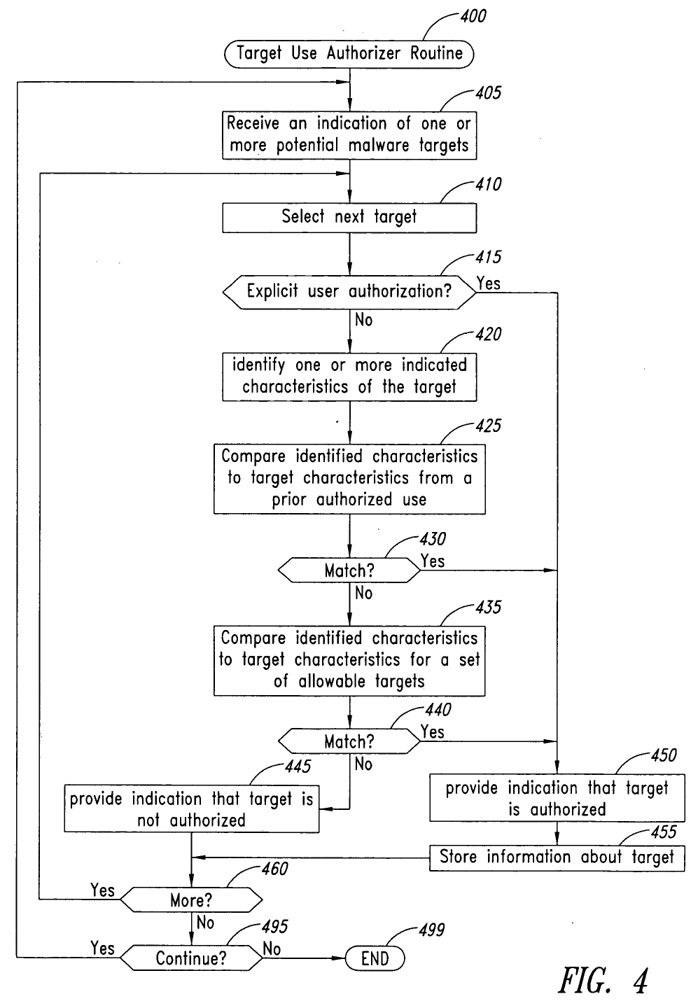

FIG. 4 is a flow diagram of an embodiment of the Target Use Authorizer routine 400. The routine may, for example, be provided by execution of an embodiment of the Target Use Authorizer component 244 of FIG. 2, such as to in this illustrated embodiment automatically determine whether to allow use of one or more identified potential malware or other targets for a computing system based on whether those targets are confirmed to be authorized. The routine may, for example, execute at startup of the computing system along with other components of an embodiment of a malware protection system, or alternatively may in some embodiments execute remotely from the computing system.

The routine begins at step 405, where an indication is received of one or more potential malware targets for a computing system, such as from the Target Identifier routine (e.g., as discussed with respect to steps 335 and 355 of FIG. 3, or instead in response to a request from the routine 400, not shown). The routine then continues to step 410 to select the next potential target, beginning with the first. In step 415, the routine then determines whether the selected target has been previously indicated by an appropriate user (e.g., a user of the computing system or a user that has appropriate permissions to authorize the target) as being authorized, such as at a prior time or instead during a contemporaneous attempted use of the target that caused the target to be identified and indicated to the routine 400. While not illustrated here, in some embodiments the routine could query an appropriate user for authorization if it has not been previously supplied.

If it was determined in step 415 that the selected target has not been previously indicated by an appropriate user as being authorized, the routine continues to step 420 to identify one or more indicated characteristics of the selected target (e.g., filesize and CRC), such as characteristics specific to the target and/or to the type of target, or instead characteristics common to all targets. The identified characteristics are then compared in step 425 to characteristics for the target from a prior time (if any), such as a prior authorized use of the target. If it is not determined in step 430 that the identified characteristics match the prior characteristics, the routine continues to step 435 to compare the identified characteristics to characteristics for one or more targets (if any) identified as being allowable (e.g., by interacting with a remote protection facilitator server or other system having information about the allowable targets). If it is not determined in step 440 that the identified characteristics match the allowable target characteristics, the routine continues to step 445 to provide an indication that the target is not authorized (e.g., to the Target Use Preventer routine or to the provider of the indication in step 305). In other embodiments, one or more other tests for determining whether a target is authorized may instead be used, whether in addition to or instead of one or more of the illustrated types of tests, and the tests used may be performed in various orders.

If it was instead determined in step 415 that the selected target has been previously indicated by an appropriate user as being authorized, or in step 430 that the identified characteristics do match the prior characteristics, or in step 440 that the identified characteristics do match the allowable target characteristics, the routine continues to step 450 to provide an indication that the target is authorized, such as in a manner similar to that of step 445. The routine then continues to step 455 to store various information about the target, such as an indication of the current authorized use of the target, a backup copy of the target for later potential restoration use, some or all of the identified characteristics (if any) for the target, etc.—such storage may occur local to the computing system and/or at a remote location. For example, while not illustrated here in detail, the routine may send information about the authorized target to a protection facilitator server, such as to potentially expand the identified allowable programs. While also not illustrated here, in other embodiments some or all such information may similarly be stored for targets that are not determined to be authorized (e.g., to prompt a more detailed automatic and/or human analysis of the target to determine whether it should be identified as an allowable target), and information about targets that are authorized and/or not authorized may further be stored in logs and/or provided to users in reports as appropriate.

After steps 445 or 455, the routine continues to step 460 to determine whether there are more potential targets, and if so returns to step 410. Otherwise the routine continues to step 495 to determine whether to continue. If so, the routine returns to step 405, and if not continues to step 499 and ends.

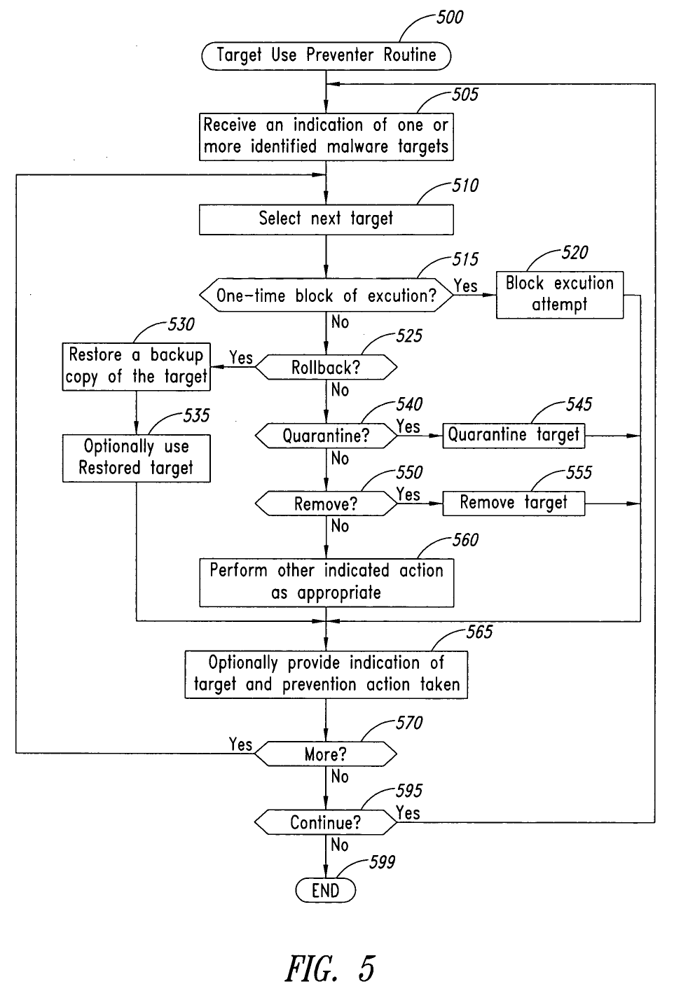

FIG. 5 is a flow diagram of an embodiment of the Target Use Preventer routine 500. The routine may, for example, be provided by execution of an embodiment of the Target Use Preventer component 246 of FIG. 2, such as to in this illustrated embodiment automatically prevent use of one or more identified malware or other targets for a computing system. The routine may, for example, execute at startup of the computing system along with other components of an embodiment of a malware protection system, or alternatively may in some embodiments execute remotely from the computing system.

The routine begins at step 505, where an indication is received of one or more identified malware targets for a computing system, such as from the Target Use Authorizer routine (e.g., as discussed with respect to step 445 of FIG. 4, or instead in response to a request from the routine 500, not shown). The routine then continues to step 510 to select the next target, beginning with the first. In step 515, the routine then determines whether preventing use of the selected target will involve a one-time block of execution of a target program or other use of target data, and if so continues to step 520 to block the execution or other use of the target in that manner (e.g., by modifying configuration or other information associated with the target, by dynamically blocking a current initiated execution of a target program, etc.). The determination of what type of use prevention technique to use for a target may be made in a variety of ways, such as based on an indication received in step 505, a type of the target, a current level of protection being provided, etc. In addition, in other embodiments one or more other use prevention techniques may instead be used, whether in addition to or instead of one or more of the illustrated types of use prevention techniques, and the use prevention techniques used may be performed in various orders.

If it was instead determined in step 515 that preventing use of the selected target will not involve a one-time block, the routine continues to step 525 to determine whether to restore a prior version of the target, such as to replace a changed version of a target program or data with an earlier version prior to the change. If so, the routine continues to step 530 to use a backup copy of the target to restore the target by replacing the current copy, and in step 535 optionally initiates use of the restored copy (e.g., if the use prevention was in response to a dynamic attempt to use the target). If it was instead determined in step 525 that preventing use of the selected target will not involve restoring a prior version of the target, the routine continues to step 540 to determine whether to quarantine the target such that the target will not be used, and if so continues to step 545 to quarantine the target as appropriate. If it was instead determined in step 540 that preventing use of the selected target will not involve a quarantine of the target, the routine continues to step 550 to determine whether to permanently remove the target from the computing system, and if so continues to step 555 to remove the target. If it was instead determined in step 550 that preventing use of the selected target will not involve removing the target, the routine continues to step 560 to perform another indicated type of use prevention action as appropriate.

After steps 520, 535, 545, 555 or 560, the routine continues to step 565 to optionally provide indications of the target and of the use prevention action taken, such as to a requester from whom the indication in step 505 was received and/or to store the information in a log for later use. After step 565, the routine continues to step 570 to determine whether there are more targets, and if so returns to step 510. Otherwise, the routine continues to step 595 to determine whether to continue. If so, the routine returns to step 505, and if not continues to step 599 and ends.

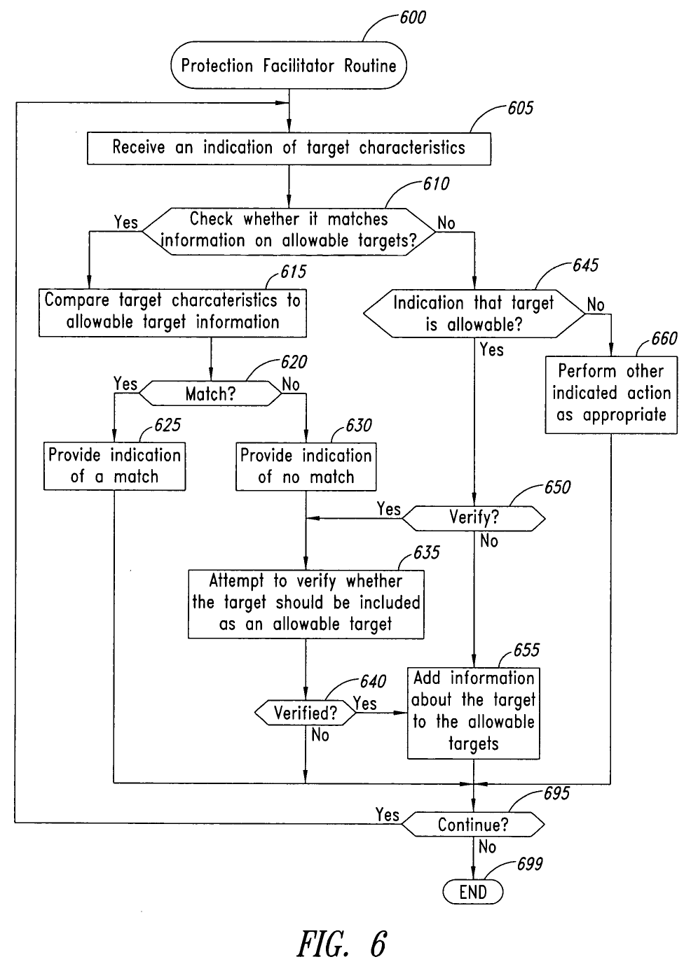

FIG. 6 is a flow diagram of an embodiment of the Protection Facilitator routine 600. The routine may, for example, be provided by execution of an embodiment of the protection facilitator system 279 of FIG. 2, such as to in this illustrated embodiment assist one or more malware protection systems in determining whether targets are authorized by using information about identified allowable targets. The routine may, for example, execute concurrently with an embodiment of a malware protection system (e.g., in response to an execution request from the malware protection system), such as at a location remote from the malware protection system.

The routine begins at step 605, where an indication is received of one or more characteristics (e.g., a signature) for each of one or more targets for a computing system, such as from the Target Use Authorizer routine (e.g., as discussed with respect to steps 435 of FIG. 4, or instead in response to a request from the routine 600, not shown). The routine then continues to step 610 to determine whether the indicated target characteristics are for matching against information about identified allowable targets, and if so continues to step 615 to compare the received target characteristics to characteristics for one or more targets (if any) identified as being allowable. If it is not determined in step 620 that the identified characteristics match the allowable target characteristics, the routine continues to step 630 to provide an indication that a match did not occur (e.g., to the Target Use Authorizer routine or to the provider of the indication in step 605), and otherwise continues to step 625 to provide an indication that a match did occur in a similar manner.

If it was instead determined in step 610 that the indicated target characteristics are not for matching against information about identified allowable targets, the routine continues instead to step 645 to determine whether an indication is received (e.g., in step 605) that the target should be identified as an allowable target, although in some embodiments such indications may not be received. If such an indication is not received, the routine continues to step 660 to perform another indicated type of action with the received target characteristics as appropriate. Otherwise, the routine continues to step 650 to determine whether to verify the received indication that the target should be identified as an allowable target—if so, or after step 630, the routine continues to step 635 to attempt to verify whether the target should be treated as an allowable target. The verification attempt may be performed in various ways (e.g., by analyzing the target to determine whether it contains any malware), while in other embodiments this type of verification may not be performed. If it is determined in step 640 that inclusion of the target with the identified allowable targets is verified, or in step 650 that verification is not to be performed, the routine continues to step 655 to add information about the target for use with other allowable target information.

After steps 625, 655 or 660, or if it was instead determined in step 640 that the target was not verified, the routine continues to step 695 to determine whether to continue. If so, the routine returns to step 605, and if not the routine continues to step 699 and ends.

Those skilled in the art will also appreciate that in some embodiments the functionality provided by the routines discussed above may be provided in alternative ways, such as being split among more routines or consolidated into fewer routines. Similarly, in some embodiments illustrated routines may provide more or less functionality than is described, such as when other illustrated routines instead lack or include such functionality respectively, or when the amount of functionality that is provided is altered. In addition, while various operations may be illustrated as being performed in a particular manner (e.g., in serial or in parallel, or synchronous or asynchronous) and/or in a particular order, those skilled in the art will appreciate that in other embodiments the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some embodiments illustrated data structures may store more or less information than is described, such as when other illustrated data structures instead lack or include such information respectively, or when the amount or types of information that is stored is altered.

From the foregoing it will be appreciated that, although specific embodiments have been described herein for purposes of illustration, various modifications may be made without deviating from the spirit and scope of the invention. Accordingly, the invention is not limited except as by the appended claims and the elements recited therein. In addition, while certain aspects of the invention are presented below in certain claim forms, the inventors contemplate the various aspects of the invention in any available claim form. For example, while only some aspects of the invention may currently be recited as being embodied in a computer-readable medium, other aspects may likewise be so embodied.

What is claimed is:

1. A method in a computing system for protecting the computing system from computer viruses, the method comprising:
executing a protection program on a computing system during startup to facilitate antivirus protection for the computing system, the executing occurring subsequent to booting of the computing system and prior to execution of other programs during the computing system startup; and
under control of the executing protection program, automatically preventing computer viruses from executing on the computing system during startup by, for each of multiple other programs that are to be executed during the computing system startup,
before the other program is executed during the computing system startup, automatically determining if the other program is unchanged since a successful execution during a prior startup of the computing system; and
unless it is determined that the other program is unchanged,
automatically determining if the other program is included in a set of programs previously identified as being authorized; and
unless it is determined that the other program is included in the set of authorized programs, automatically preventing the other program from being executed,
so that unauthorized programs are not executed during computing system startup.

2. The method of claim 1 wherein one or more of the multiple other programs each contains a computer virus, and wherein the automatic preventing of computer viruses from executing on the computing system during startup includes blocking execution of each of the one or more other programs without having identified that other program as containing a computer virus.

3. The method of claim 1 wherein the automatic determining if an other program is unchanged since a successful execution during a prior startup includes determining that one or more current characteristics of the other program each match a corresponding characteristic of the other program at the prior startup, the one or more current characteristics including at least one of a file size of the other program, a checksum of the other program, a cyclical redundancy checking value for the other program, and at least a portion of the contents of the other program.

4. The method of claim 1 wherein the automatic determining if an other program is unchanged since a successful execution during a prior startup includes determining that the other program is not unchanged if the other program has not previously executed successfully during startup of the computing system.

5. The method of claim 1 wherein the automatic preventing of an other program from being executed includes, after the other program is determined to be changed since a successful execution during a prior startup, replacing the other program with a backup copy of the other program prior to the change.

6. The method of claim 1 wherein the automatic preventing of an other program from being executed includes querying a user of the computing system to provide authorization to execute the other program and blocking execution of the other program if the authorization is not received from the user.

7. The method of claim 1 wherein the automatic determining if an other program is included in the set of programs previously identified as being authorized includes interacting with a remote server that stores information about the set of authorized programs.

8. The method of claim 7 wherein multiple copies of the protection program each execute on one of multiple distinct computing systems to facilitate antivirus protection for those computing systems, and wherein each of the protection program copies provide information to the remote server about programs that execute on the computing system on which the protection program executes, so that the remote server can dynamically expand the set of authorized programs based on the information provided from the multiple protection program copies in a distributed manner.

9. The method of claim 1 further comprising, under control of the executing protection program, automatically preventing computer viruses from executing on the computing system after startup by, for each of multiple additional other programs that are to be executed after the computing system startup, automatically preventing the additional other program from being executed unless the additional other program is determined to be authorized.

10. A computer-implemented method for protecting a computing system from execution of unwanted programs, the method comprising:
identifying one or more programs to be executed during startup of a computing system; and
automatically preventing unwanted programs from being executed during the computing system startup by, for each of the identified programs,
before the identified program is executed during the computing system startup, automatically determining whether the identified program is confirmed as being allowable for the computing system; and
unless it is determined that the identified program is confirmed as being allowable, automatically preventing the identified program from being executed.

11. The method of claim 10 wherein the automatic determining of whether an identified program is confirmed as being allowable for the computing system includes confirming that the program is allowable for the computing system if the program is identified as being unchanged since a prior startup of the computing system.

12. The method of claim 11 wherein the identifying that a program is unchanged since a prior startup of the computing system includes determining that, for at least one characteristic related to contents of a program, an identified value of the characteristic for the program matches an identified value of the characteristic for a copy of the program that was executed during the prior startup.

13. The method of claim 12 wherein the at least one characteristics related to the contents of a program include one or more of a file size of the program, a checksum of the program, a cyclical redundancy checking value for the program, and at least a portion of the contents of the program.

14. The method of claim 12 wherein the at least one characteristics related to the contents of a program include metadata for the program that is distinct from the contents.

15. The method of claim 10 wherein one or more predefined program characterizations each has a specified value for one or more indicated program characteristics of an allowable program, and wherein the automatic determining of whether an identified program is confirmed as being allowable for the computing system includes confirming that the identified program is allowable for the computing system if the identified program matches at least one of the predefined program characterizations.

16. The method of claim 15 wherein an identified program is determined to match a program characterization if the identified program has identified values for the program characteristics indicated for that program characterization that match the specified values for those program characteristics for the program characterization.

17. The method of claim 15 wherein the indicated program characteristics for each of the program characterizations include one or more of a file size of a program, a checksum of a program, a cyclical redundancy checking value for a program, and at least a portion of contents of a program.

18. The method of claim 15 wherein the indicated program characteristics for each of the program characterizations include metadata for a program that is distinct from contents of the program.

19. The method of claim 15 including defining at least some of the program characterizations based on programs identified as authorized for the computing system.

20. The method of claim 15 including providing information to a distinct computing system about one or more of the identified programs so that the distinct computing system can define program characterizations based on information provided from multiple computing systems being protected from execution of unwanted programs.

21. The method of claim 15 wherein the automatic determining of whether an identified program is confirmed as being allowable for the computing system includes providing information about the identified program to a distinct computing system in order to obtain an indication from the distinct computing system regarding whether the identified program is confirmed as being allowable for the computing system.

22. The method of claim 15 including, before matching an identified program to at least one of the predefined program characterizations, obtaining information about at least some of the program characterizations from a distinct computing system.

23. The method of claim 15 wherein the predefined program characterizations include multiple predefined program characterizations for multiple allowable programs, and wherein the predefined program characterizations are not specific to the computing system.

24. The method of claim 10 wherein the automatic determining of whether an identified program is confirmed as being allowable for the computing system includes confirming that the identified program is allowable for the computing system based on an indication to allow the identified program received from a user associated with the computing system.

25. The method of claim 10 wherein the automatic determining of whether an identified program is confirmed as being allowable for the computing system includes confirming that the identified program is not allowable for the computing system if the identified program is identified as being of one or more types of unwanted programs, the unwanted program types including a computer virus, a computer worm, a Trojan, malware, spyware, adware, a browser hijacker, a dialer, a rootkit, and a dropper.

26. The method of claim 10 wherein the method further includes automatically preventing unwanted programs from being executed after the computing system startup by, for each of at least some programs whose execution is initiated after the computing system startup, automatically preventing the program from being executed unless it is determined that the program is confirmed as being allowable.

27. The method of claim 10 wherein the automatic determining of whether an identified program is confirmed as being allowable for the computing system is performed dynamically during the computing system startup.

28. The method of claim 10 wherein the automatic determining of whether an identified program is confirmed as being allowable for the computing system is performed by a protection program executed on the computing system.

29. The method of claim 10 wherein the automatic determining of whether an identified program is confirmed as being allowable for the computing system is performed by a distinct computing system remote from the computing system.

30. The method of claim 10 wherein the automatic preventing of an identified program from being executed includes blocking execution of the identified program.

31. The method of claim 10 wherein the automatic preventing of an identified program from being executed includes replacing the identified program with a copy of the identified program that is allowable for the computing system.

32. The method of claim 10 wherein an identified program has been changed by malware, and wherein the automatic preventing of the identified program from being executed includes replacing the identified program with a copy of the identified program prior to the change.

33. The method of claim 10 wherein the automatic identifying of the programs to be executed during startup of a computing system includes analyzing configuration information for the computing system and/or dynamically identifying attempts to initiate execution of programs on the computing system.

34. The method of claim 10 further comprising automatically preventing use of non-executable data by a program unless it is automatically determined that the data is allowable for the computing system.

35. A computer-readable medium whose contents enable a computing device to prevent execution of malware programs, by performing a method comprising:
automatically protecting a computing device from malware programs by, for each of one or more programs identified to be executed on the computing device,
attempting to automatically determine that the identified program is not a malware program; and
unless the automatic determining confirms that the identified program is not a malware program, automatically preventing the identified program from executing.

36. The computer-readable medium of claim 35 wherein the attempting to automatically determine that an identified program is not a malware program includes confirming that the identified program is not a malware program if the identified program is determined to be allowable.

37. The computer-readable medium of claim 35 wherein the computer-readable medium is a memory of a computing device.

38. The computer-readable medium of claim 35 wherein the computer-readable medium is a data transmission medium transmitting a generated data signal containing the contents.

39. The computer-readable medium of claim 35 wherein the contents are instructions that when executed cause the computing device to perform the method.

40. The computer-readable medium of claim 35 wherein the contents include one or more data structures for use in preventing execution of malware programs, the data structures comprising multiple entries corresponding to programs determined to be allowable such that each entry includes a characterization of an allowable program, each characterization of an allowable program containing one or more of a file size of the program, a checksum of the program, a cyclical redundancy checking value for the program, and a portion of contents of the program.

41. A computing system configured to prevent unwanted changes affecting computing system execution, comprising:
a target identifier component that is configured to identify one or more groups of data to be used during startup of a computing device;
a target use authorizer component that is configured to, for each of the identified groups of data and before the identified group of data is used during the computing device startup, automatically determine whether the identified group of data is unchanged since a prior use of a copy of the identified group of data and/or whether a change of the identified group of data since the prior use was authorized; and
a target use preventer component configured to, for each of the identified groups of data and unless it is determined that the identified group of data is unchanged since the prior use or that the change of the identified group of data since the prior use was approved by an authorized user, automatically prevent the identified group of data from being used during startup of the computing device.

42. The computing system of claim 41 wherein the target use preventer component is further configured to allow an identified group of data to be used during startup of the computing device if the identified group of data matches an group of data previously identified as being allowable.

43. The computing system of claim 42 further comprising a protection facilitator component that is configured to identify groups of data that are allowable.

44. The computing system of claim 41 wherein each of the identified groups of data is a program to be executed during startup of the computing device.

45. The computing system of claim 41 wherein the computing system is distinct from the computing device.

46. The computing system of claim 41 wherein the target identifier component, the target use authorizer component, and the target use preventer component are each executing in memory of the computing system.

47. The computing system of claim 41 wherein the target identifier component consists of a means for identifying one or more groups of data to be used during startup of a computing device, wherein the target use authorizer component consists of a means for, for each of the identified groups of data and before the identified group of data is used during the computing device startup, automatically determining whether the identified group of data is unchanged since a prior use of a copy of the identified group of data and/or whether a change of the identified group of data since the prior use was authorized, and wherein the target use preventer component consists of a means for, for each of the identified groups of data and unless it is determined that the identified group of data is unchanged since the prior use or that the change of the identified group of data since the prior use was approved by an authorized user, automatically preventing the identified group of data from being used during startup of the computing device.
